(19) United States
(12) Patent Application Publication
(10) Pub. No.: US 2005/0242266 A1
(43) Pub. Date: Nov. 3, 2005

(54) Locking & seismic hanging system

(76) Inventor: Robert Lemire, Kings Park, NY (US)

Correspondence Address: ROBERT J. LEMIRE, P.O. BOX 299, KINGS PARK, NY, 11754, US

(21) Appl. No.: 10/834,953

(22) Filed: Apr. 30, 2004

(51) Int. Cl. B60R 1/02

(52) U.S. Cl. 248/690

(57) ABSTRACT

This hanging system uses a compressive force-producing component such as an elastomeric cord or spring for locking an object on the wall. It makes use of simple brackets and two cords. One cord is flexible but has very little stretch capability. This cord holds the weight of the object while the elastomeric cord provides a flexible compressive force on the object and on the wall brackets. This compressive force normally locks the object so that it does not move or tilt due to normal vibrations. However, during severe vibrations, such as during a seismic event, the elastomeric spring forces allow the object to move and to counter the effects of the vibratory forces experienced by the object.

### FIELD OF INVENTION

This invention generally relates to a system for hanging objects, such as pictures, mirrors, plaques, etc., on a surface so that they remain in place and are able to withstand the effects of an earthquake without falling off the wall.

### BACKGROUND OF THE INVENTION

Picture hanging devices are generally concerned with only overcoming the effects of gravity to hold an object on a wall. Some hanging devices have been developed for locking objects onto the hanger or onto a bracket mounted on a wall; however, they are somewhat complicated and sometimes require special tools. It would be useful to have the ability to quickly and easily hang an object so that it is locked in position on a wall. In certain areas earthquakes cause many objects hung on the wall to fall and become damaged during a seismic event. The locking of objects onto the wall cam mitigate this effect; and objects having a means for damping out the shock of the earthquake can further help in lessening the damage.

### SUMMARY OF THE INVENTION

It is the object of the present invention to provide a useful means for hanging objects so that they are locked in position and have a shock-absorbing feature built into the hanging system. A system with top and bottom cord loops where one of the loops has a shock-absorbing feature is what is being proposed in this application.

Several embodiments of this system are being presented. The first uses a wall mounted hanger that has a flexible cord extending down from the hanger and interfacing with brackets on the bottom of the object for supporting the object. Also extending from the hanger is an elastomeric cord that extends up to brackets on the top of the object so that a downward force is applied to the object and locks it onto the wall.

Another embodiment is in the form of a picture frame back or bracket affixed to the object so that an upward cord extends from the object and interfaces with a bracket mounted on the wall. Extending down from the back or bracket on the object is an elastomeric cord that interfaces with a second bracket so that this cord is applying a downward force on the object. This combination of components also locks the object onto the wall.

Both of these embodiments provide the support needed to overcome gravity and to provide shock-absorbing movement of the object during a seismic event.

### BRIEF DESCRIPTION OF DRAWINGS

FIG. 1 is an elevational view from the back surface of an object looking at the hanger assembly mounted on a wall.

FIG. 2 is an elevational view from inside the back panel of a picture frame looking through cutouts in the panel at the top and bottom brackets mounted on the wall.

### DETAILED DESCRIPTION

This hanging system can be implemented using a wide array of component designs. Two of the simplest designs are presented with the use of these figures.

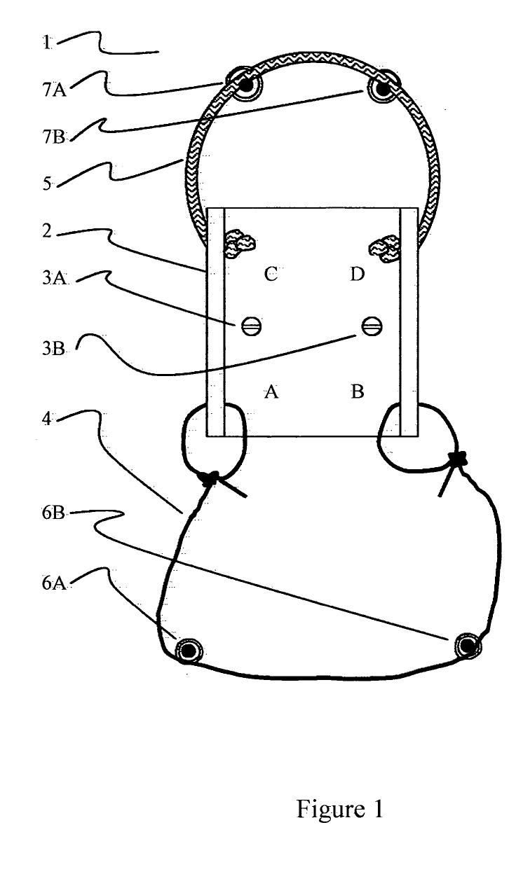

Firstly, referring to FIG. 1 which is an elevational view from the back surface of an object looking at the hanger assembly 1 mounted on a wall with screws 3A & 3B. The hanger body 2 is a U-channel with holes going through the legs of the channel at A, B, C & D. The bottom cord 4 is affixed to the hanger body 4 at holes A & B. The cord 4 proceeds from the left side of the hanger body and goes around the bottom of screws 6A & 6B. Cord 4 continues around and ends on the right side of the hanger body and provides support for the object. Screws 6A & 6B are protruding from the back of the bottom of the object, and their heads act as brackets for holding cord 4. Elastomeric cord 5 goes through holes C & D and has its ends knotted on the inside of the body to affix it to hanger body 2. Elastomeric cord 5 is stretched so that it goes around the top of screws 7A & 7B. Screws 7A & 7B are protruding from the top back of the object, and their heads act as brackets for holding elastomeric cord 5 onto the object. Stretched elastomeric cord 5 effectively locks the object onto the hanger body by pulling the object down by the 7A & 7B screws while it is being restrained by cord 4 on screws 6A & 6B. This action holds the object on the wall even though the wall may experience vibrations or movement.

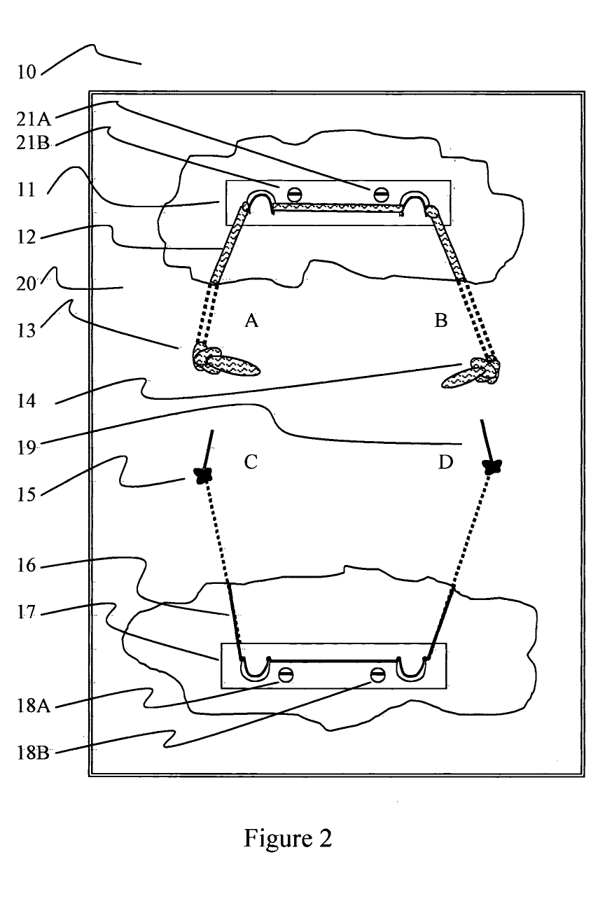

Secondly, referring to FIG. 2 which is an elevational view of the hanging system 10 from inside the back panel 20 of a picture frame looking through cut-outs in the panel at the top and bottom brackets 11 & 17. Brackets 11 & 17 are mounted on the wall with screws 18A & 18B for the bottom bracket and screws 21A & 21B for the top bracket. Back panel 20 has holes A, B, C, & D. Cord 12 is knotted at 13 and goes through hole A in the back. Cord 12 then goes around the upward facing hooks on bracket 11 and then through hole B where it is knotted again at 14. Elastomeric cord 16 is knotted at 15 and goes through hole C in back 20 then around the downward facing hooks of bottom bracket 17. From the bottom bracket 17 it goes back through hole D where it is knotted at 19 on the inside of the back 20. Elastomeric cord 16 is stretched so that it can go around the hooks on bracket 17. This stretching provides the force for locking the back onto the top and bottom brackets 111 & 17 and holds it on the wall even though the wall may experience vibrations or movement.

While the invention has been illustrated and described in the above specification it is not intended to be limited to the details shown, since it will be understood that various omissions, modifications, substitutions, and changes in the form and details of the devices illustrated can be made by those skilled in the art without departing from the spirit of the present invention. For instance, the elastomeric cords can be replaced by metal springs, or a combination of springs and non-stretching cord; the hangers can be affixed to the middle of small objects or two hangers can be used one on each side of the object for larger objects.

1. A hanging system for supporting and locking an object onto a wall by exerting a continuous (flexible) compressive force from the top to the bottom of the object.

2. The hanging system of claim 1 wherein a hanger body is configured to be affixed to a surface and having a means for affixing a non-stretching downward cord loop engaging brackets affixed to the bottom of an object, and further configured to have an upward elastomeric cord loop for engaging brackets affixed to the top of the object, whereby said object is supported by the bottom cord and locked onto the hanger by the compressive force exerted by the stretched elastomeric cord.

3. A hanging system for supporting and locking an object onto a wall by exerting a continuous (flexible) compressive force from the object to top and bottom brackets affixed to the wall.

4. The hanging system of claim 3 wherein the object is configured to have an (upper) lower non-stretching cord loop engaging an upward facing wall mounted top bracket, and further configured to have a (lower) upper elastomeric cord loop engaging a downward facing wall mounted bracket, whereby said object is supported by the top cord and locked onto the wall by the compressive force exerted by the stretched elastomeric cord.

5. (canceled)
